(19) United States
(12) Patent Application Publication
(10) Pub. No.: US 2015/0089438 A1
(43) Pub. Date: Mar. 26, 2015

(54) SYSTEM AND METHOD FOR GROUPING APPLICATIONS AND APPLICATION RESOURCES ON AN INTERFACE OF A COMPUTING DEVICE

(71) Applicant: Kobo Inc., Toronto (CA)

(72) Inventors: James Wu, Newmarket (CA); Daniel Hill, Toronto (CA); Robin Bennett, Beeton (CA)

(73) Assignee: Kobo Inc., Toronto (CA)

(21) Appl. No.: 14/035,309

(22) Filed: Sep. 24, 2013

(51) Int. Cl. G06F 3/0482; G06F 3/0485

(52) U.S. Cl. CPC G06F 3/0482; G06F 3/0485
USPC 715/776; 715/810; 715/784

(57) ABSTRACT

Multiple groupings of application resources are displayed on, for example, an application launch interface of the computing device. Each of the multiple groupings may be associated with a corresponding category from the plurality of categories. Each application resource of each of the multiple groupings can be provided for use with one of the plurality of applications that is installed on the computing device and which is associated with the category of its grouping. The groupings of application resources can be treated as a single object in response to input.

### TECHNICAL FIELD

Examples described herein relate generally to a system and method for grouping applications and application resources on an interface of a computing device.

### BACKGROUND

Computing devices increasingly permit for users to install a large number of applications (or “apps”). The applications of a computing device in turn use a variety of application resources, many of which can be specific to an application. Computing devices typically provide an application launch interface (e.g., home screen, start menu) from which a user can select an application for launch. Such interfaces typically employ multiple screens or folders to enable the user to view and select from all of the installed applications on a computing device.

Many such computing devices serve a variety of purposes of functionality, including the consumption of content, such as music, videos and e-books. Mufti-function devices, such as cellular-telephony or messaging devices, can utilize specialized applications (E.g., e-reader apps) to render content.

### BRIEF DESCRIPTION OF THE DRAWINGS

FIG. 1 illustrates a system for utilizing applications and providing application resources on a computing device, according to an embodiment.

FIG. 2 illustrates an example of a mobile computing device that is configured to group applications and application resources, according to an embodiment.

FIG. 3 illustrates a device system for grouping application resources and/or applications on a computing device, according to one or more embodiments.

FIG. 4 illustrates a method for grouping applications and/or application resources on an application launch page, according to an embodiment.

FIG. 5A illustrates an example application launch interface in which applications and application interfaces are displayed in groups, according to an embodiment.

FIG. 5B illustrates an example of an e-book grouping provided on an application launch interface, according to an embodiment.

### DETAILED DESCRIPTION

Examples described herein provide for operating a computing device to group application resources on a launch interface, where the groupings are based on a category designation for a corresponding application. Each group of application resources can include applications and files utilized by those applications. The computing device can interpret input as being applicable to one or more groupings as a whole. For example, a computing device can interpret directional input by moving select groupings (e.g., scrolling, navigation, etc.) of the application resources about the application launch interface.

In an embodiment, each of a plurality of applications that are installed on the computing device is associated with one of a plurality of categories. Multiple groupings of application resources are displayed on, for example, an application launch interface of the computing device. Each of the multiple groupings may be associated with a corresponding category. Each application resource of each of the multiple groupings can be provided for use with one of the plurality of applications that is installed on the computing device and which is associated with the category of its grouping. The groupings of application resources can be treated as a single object in response to input, such as, for example, directional, navigation or scrolling input.

As used herein, application resources includes files and/or data sets for use with applications. Examples of application resources include media files (e.g., movie files, music files,), documents (word processing documents, spreadsheets), and e-books. Application resources can also include metadata associated with an application and/or an application resource. Examples of metadata that can be included in the application grouping include, for example, album art for a media file that corresponds to a song, box cover art for a media file that corresponds to a movie, or a cover jacket for an e-book. Metadata can also include, for example, information determined from the user's use of an application, such as the amount of time or pages the user has remaining to complete reading of an e-book.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

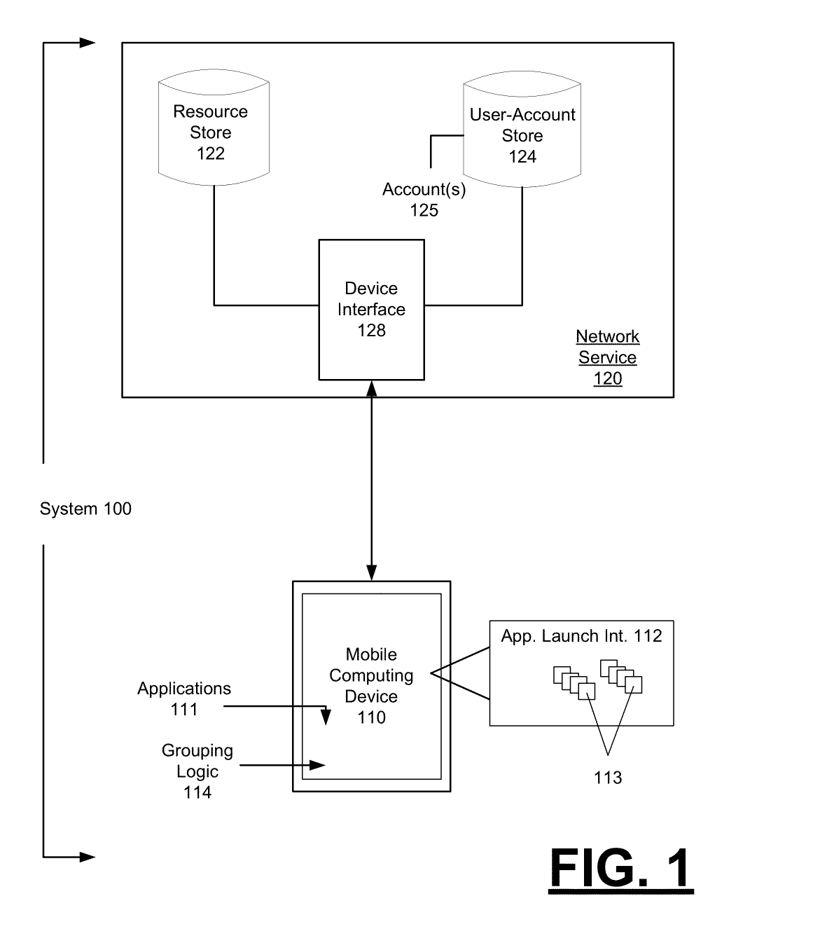

FIG. 1 illustrates a system for utilizing applications and providing application resources on a computing device, according to an embodiment. In an example of FIG. 1, system 100 includes a mobile computing device 110 and a network service 120. The network service 120 may include multiple servers and other computing resources that provide various services in connection with one or more applications that are installed on the computing device. By way of example, in one implementation, the network service 120 can provide e-book services which communicate with an e-book application on the mobile computing device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The mobile computing device 110 can correspond to any computing device on which applications and application resources (e.g., e-books, media files, documents) can be rendered and consumed. For example, the mobile computing device 110 can correspond to a tablet, telephony/messaging device (e.g., smart phone) or portable computing device. In one implementation, for example, mobile computing device 110 can run an e-reader application that links the device to the network service 120 and enables e-books provided through the service to be viewed and consumed. In another implementation, the mobile computing device 110 can run a media playback or streaming application which receives files or streaming data from the network service 120.

In some implementations, the mobile computing device 110 is equipped with hardware and software to optimize certain application activities, such as reading electronic content (e.g., e-books). For example, the mobile computing device 110 can have a tablet like form factor, although variations are possible. In some cases, the mobile computing device 110 can also have an electronic paper type display.

The network service 120 can include a device interface 128, which communicates with individual devices that access the service. Among other resources, the network service 120 can include a resource store 122 and a user account store 124. The user account store 124 can associate mobile computing device 110 with a user and an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The mobile computing device 110 may be associated with the user account 125, and multiple devices may be associated with the same account. As described in greater detail below, the mobile computing device 110 can store resources (e.g., e-books) that are purchased or otherwise made available to the user of the mobile computing device 110, as well as archive resources that have been purchased for the user account 125, but are not stored on the particular mobile computing device.

According to one aspect, the mobile computing device 110 includes programming logic that identifies installed applications 111 on the mobile computing device. The installed applications 111 can include those applications downloaded from, for example, the network service 120 (or from another source such as an “app store”), or those applications which are pre-installed on the device. The installed applications 111 can be made available for use through one or more interfaces of the computing device 110, including through, for example, an application launch interface 112.

A grouping logic 114 can execute on the computing device in order to perform operations that include (i) determining a category of an application, (ii) selecting application resources for categorized applications, and (iii) grouping applications and application resources in accordance with the determined category of the application. As described in greater detail, the grouping logic 114 can determine individual groupings 113 which are displayed on the application launch interface 112. The individual groupings 113 can identify applications and/or application resources 113 for defined categories.

The application launch interface 112 can display icons or other graphics that represent the contents of each grouping 113. Additionally, the application launch interface 112 can include logic that provides groupings 113 in a state in which the individual groupings are treated as a single object, in response to, for example, select user input and other events. In some variations, groupings can also be accessed to view the contents in, for example, a partially rendered form.

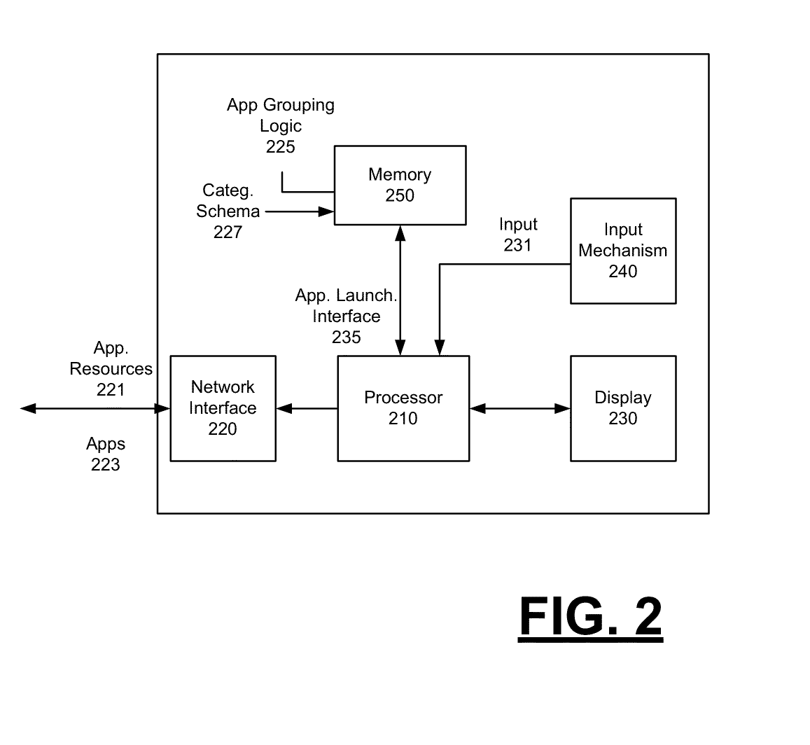

FIG. 2 illustrates an example of a mobile computing device, according to an embodiment. The mobile computing device 200 can include a processor 210, a network interface 220, a display 230, one or more input mechanisms 240, and a memory 250. The processor 210 can utilize the network interface 220 to communicate with a network service 120 (see FIG. 1). In communicating with the network service 120, the mobile computing device 110 can receive application resources 221, such as e-books or media files, that the user elects to purchase or otherwise download from the network service 120. The application resources 221 that are downloaded onto the mobile computing device 110 may be stored in the memory 250. In addition to application resources 221, mobile computing device 200 can download application 223 from, for example, network service 120.

In some embodiments, the display 230 corresponds to an electronic paper type display, which mimic conventional paper in the manner in which they display content. Examples of such display technologies include electrophoretic displays, electrowetting displays, and electrofluidic displays. Examples described herein further appreciate that the media in which electronic type displays are provided on can vary, and include, for example, plastic or paper combined with transistor elements or other circuitry. In variations, the display 230 can correspond to, for example, a liquid crystal display (LCD) or light emitting diode (LED) display that illuminates in order to provide content generated from processor 210.

According to some embodiments, the memory 250 can also store an instruction set for implementing application grouping logic 225 and an application launch interface 235. Additionally, the memory 250 can store a categorization schema 227, which can include pre-defined categories for applications and application resources (e.g., “Reading,” “Entertainment,” and “Social”). In some variations, the categorization schema 227 can include user-defined categories (e.g., “Vacation Material” or “Personal”).

The processor 210 can operate to display groupings of applications 223 or application resources 221 through the application launch interface 235. Each such grouping can be displayed on the application launch interface 235 as a single object or entity. When input 231 is received through the input mechanism 240, the processor 210 can interpret the input 210 as a group input, which results in a corresponding operation being performed one or more of the groupings. In particular, the action resulting from the input 231 is performed on each grouping in a manner that treats each grouping as a single object. For example, a visual representation of one or more groupings on the application launch interface 235 can be manipulated based on the group input 231.

According to implementations, the input mechanism 240 can correspond to, for example, a touch sensitive surface, such as one integrated with the display 230 (e.g., touch screen). As another example, the input mechanism 240 can correspond to a button or switch that the user can press or otherwise actuate. According to some embodiments, the input mechanism 240 can be operated to enable the user to specify an input corresponding to any one of scrolling groupings, moving groupings, organizing groupings, transferring groupings, or performing other input actions that affect multiple applications or application resources of a given grouping at one time.

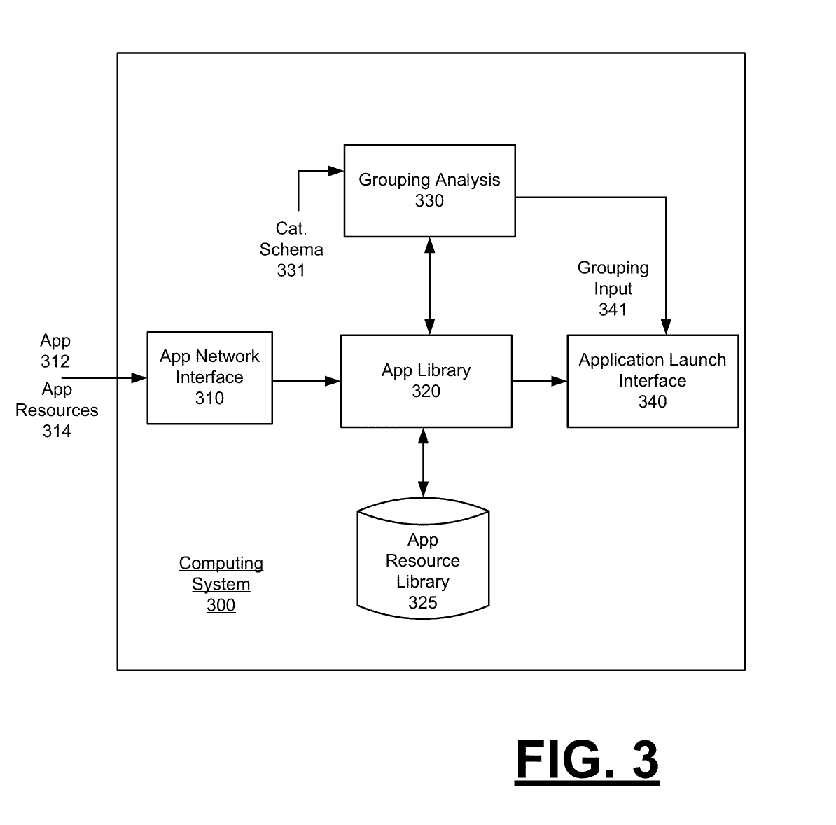

FIG. 3 illustrates a device system for grouping application resources and/or applications on a computing device, according to one or more embodiments. For example, in reference to FIG. 3, a mobile computing system 300 can implement programmatic components for grouping application resources and applications, as well as providing other functionality such as communicating with a network service (such as network service 120, shown in FIG. 1). In some implementations, the computing system 300 can be implemented as an application or combination of applications that runs on a mobile computing device (e.g., such as shown by FIG. 1 or FIG. 2).

In an example of FIG. 3, the system 300 includes an application network interface 310, an application library 320, a grouping analysis component 330 and an application launch interface 340. The programmatic components shown with the computing system 300 can be provided as part of an application that runs on the device of the computing system 300. For example, the user can download an application onto mobile computing device, to obtain functionality such as described herein, as well as to communicate with a network service 120. Alternatively, the application can be embedded or otherwise preinstalled with other programmatic elements for providing such functionality on a computing device.

The application network interface 310 includes application or logic which enables the device to use, for example, a wireless Internet connection, to connect to the network service 120 (see FIG. 1). In connecting with the service, the application network interface 310 can transmit data that enables the network service 120 to identify mobile computing system 300 (or alternatively the user) so that the network service 120 can determine the account associated with the mobile computing device. The application network interface 310 can be used to retrieve, for example, application resources 325, such e-books or music files, from the network service 120. For example, in identifying the mobile computing system 300 to the network service 120, the network service may be able to procure payment information (e.g., stored credit card) that can be used to charge users account when purchasing a new e-book.

In identifying the mobile computing system 300, the network service 120 can identify what applications 312 and/or application resources 314 belong to the account of that device. The applications 312 and/or application resources 314 that are transmitted to the mobile computing system 300 include those that are purchased from the device, or those that the user requested to download. In variations, applications 312 and/or application resources 314 can automatically be downloaded to the device in response to the occurrence of certain conditions. For example, the user can purchase an application resource on another device, and then subsequently connect to the network service 120 via the mobile computing system 300 to automatically receive their previously purchased resource. Alternatively, network service 120 can be configured to push applications 312 and/or application resources 314 to the mobile computing system 300, based on, for example, user account settings, subscription rules, and various other business logic considerations. Still further, application resources 314 such as documents, images or other files can be created on the device through, for example, a user's interaction with the device. Additionally, applications 312 can be pre-installed or loaded onto the device from portable memory or other mechanisms.

The application library 320 can include functionality for managing the local storage of applications 312 and application resources 314 in an application resource store 325. For example, the application library 320 can include a universal search feature, and/or operative system level functionality for organizing applications 312 and application resources 314 based on, for example, metadata. In variations, the application library 320 and application resource store 325 can be provided by separate applications which manage different applications. Still further, in another example, the application resource store 325 can be provided with or as part of a file management library (e.g., such as provided through the operating system of the computing device 300).

In some embodiments, the computing system 300 implements grouping analysis logic 330 to programmatically identify a category of an installed application (such as provided through the application library 320). The grouping analysis logic 330 can categorize an application based on a subject category classification. Examples of subject category classifications can include “social,” “entertainment,” “browsing,” or “reading.” In variations, categories can be used defined. For example, a user can create a folder based on an event such as a user's trip. A category schema 331 can be used to define the categories used by the grouping analysis logic 330. In one implementation, grouping analysis logic 330 programmatically assigns categories (e.g., subject categories) to installed applications using metadata associated with either the application (e.g., category of application as provided by network service) or with the application resources of the particular application.

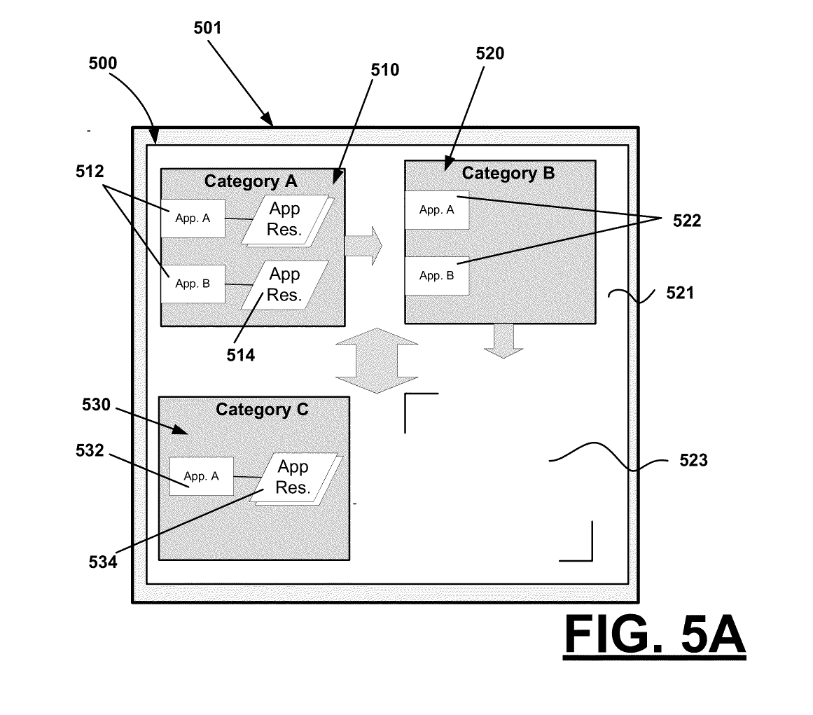

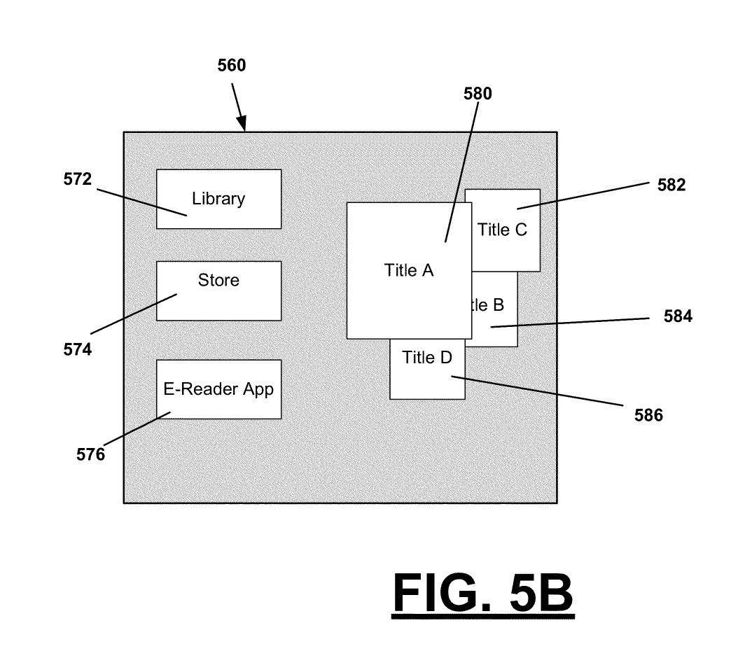

In one implementation, the application launch interface 340 can include an interface that occupies a screen or portion of the computing device. An example of an application launch interface 340 is shown by FIG. 5A. In another implementation, the application launch interface can correspond to a band or overlap that occupies a portion of a screen. For example, the application launch interface can be generated as an overlay that overlaps other content or portions of a display screen.

According to some embodiments, the application launch interface 340 uses grouping input 341 from the grouping analysis logic 330 in order to generate graphic representations of groupings. At least some individual groupings provide visual representations that identify one or more applications of a particular category and one or more resources for the identified applications. For example, a grouping can correspond to “Social” and the application launch interface 340 may display entries or content corresponding to recent postings or feeds. In a variation, each grouping generated from the application launch interface 340 can include representations (e.g., icons) of two or more applications of a same category.

Methodology

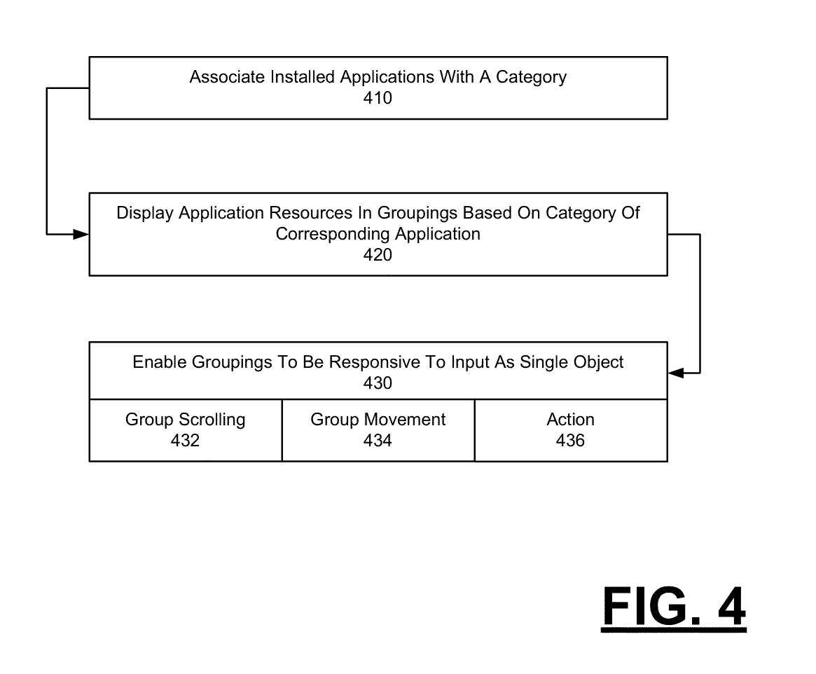

FIG. 4 illustrates a method for grouping applications and/or application resources on an application launch page, according to an embodiment. A method such as described with an example of FIG. 4 may be implemented using components such as described with FIG. 1, FIG. 2 or FIG. 3. Accordingly, reference may be made to elements of other figures for purpose of illustrating suitable elements or components for performing a step or sub-step being described.

With reference to FIG. 4, an installed application is associated with a category (410). For example, computing device 110 can download an application, and grouping analysis logic 330 can perform operations to categorize the newly installed application based on, for example, categorization metadata associated with the application. Alternatively, the grouping analysis logic 330 can scan installed applications and perform categorization as needed. The categorization schema 331 used to categorize applications can be updated programmatically by the network service 120. In a variation, the categorization schema 331 can be altered by the user.

Once the grouping determination is made, a visual representation of each grouping can be provided (420). The visual representation of at least one or more groupings can correspond to displaying representations (e.g., icons, text) of one or more applications and corresponding application resources of a particular category (422). Thus, for example, a grouping can be displayed with a visual representation of one or more applications that comprise the grouping, as well as visual representations of select application resources for the applications of the grouping. The application resources that are selected for display as part of the grouping can include, for example, (i) recently used application resources, (ii) frequently used application resources, and/or (iii) recommended application resources. For example, a grouping for a category of “reading” can display one or more e-reader applications, as well as application resources corresponding to e-books, e-magazines and/or electronic comic books that the user is in progress of reading, recently or frequently accessed, or which are recommended for the user.

The computing device can display each grouping in a manner where the grouping is responsive to input as a single object (430). For example, the computing device can process directional input for a grouping (or set of multiple groupings) displayed on an application launch interface by moving the grouping (or groupings) as a single object (432). Likewise, multiple groupings can be scrolled as individual objects (434). Still further, other actions can be performed on a grouping that affects the groupings as a whole (436). For example, a short cut action can be generated to enable the user to select a grouping, or to transmit a grouping to another device.

According to an aspect, each grouping can have a displayed state in which the computing device treats the grouping as a single object for purpose of responding to an input. Additionally, each grouping can have a selected state in which individual items of the grouping can be selected or processed for input independently of other items that comprise that grouping. For example, a user can scroll through groupings of applications and/or application resources, select a particular grouping, and then further select an application or application resource from the selected grouping.

Example Application Launch Interface

FIG. 5A illustrates an example application launch interface in which applications and application interfaces are displayed in groups, according to an embodiment. FIG. 5B illustrates an example of a grouping for an application launch interface, according to an embodiment. Examples such as described with FIG. 5A and FIG. 5B can be implemented using a computing device such as described with examples of FIG. 1, FIG. 2 or FIG. 3.

In example of FIG. 5A, an application launch interface 500 is provided on a display of a computing device 501. The application launch interface 500 can display multiple groupings 510, 520, 530, where each grouping comprises graphic representations of applications and/or application resources for a particular category. For example, as described with an embodiment of FIG. 3, grouping analysis logic 330 can determine a category for an individual application, and the application and its application resources can be assigned to a grouping of that category. With regard to individual groupings, some implementations provide that the graphic representations of each application can identify that application from other applications. Likewise, the graphic of each application resource can identify the application resource from other application resources residing (e.g., icon of book cover) on, for example, the particular computing device.

In some embodiments, visual representations of applications and application resources can be used to identify the contents of the groupings. For example, metadata associated with the select application resources (e.g., jacket covers for e-books, completion time for e-book) can be displayed as part of the grouping. Still further, in some examples, the application resources of the groupings can be represented by partial content renderings. For example, an application resource corresponding to a web page or document can be represented by a snap-shot of that document/web page.

In an example of FIG. 5A, the grouping 510 can include multiple applications 512 and corresponding application resources 514 that are assigned to a first category. The grouping 520 can include multiple applications 522 that are assigned to a second category. Still further the grouping 530 can include the application 532 and multiple application resources 534. Each grouping 510, 520, 530 can exist in a state in which inputs received on the application launch interface 500 are processed in a manner that affects one or more groupings as a whole. For example, directional input can cause scrolling of the groupings 510, 520, 530, or movement of one grouping 520 from one location 521 to another location 523.

Example Grouping

FIG. 5B illustrates an example of a grouping for an e-reader application, according to an embodiment. E-readers refer to applications that render and enable utilization of e-books. E-books are a form of an electronic publication that can be viewed on computing devices with suitable functionality. In an example of FIG. 5B, a grouping 560 can include short-cuts for launching specific features of an application, such as a library 572, online store 574 (e.g., such as provided through network service 120 of FIG. 1) and e-reader application 576. In variations, the grouping 560 can identify multiple sources for e-books, including local sources (e.g., library 572) or remote sources (e.g., online store 574). A select set of application resources can be displayed with short-cuts that correspond to specific e-book titles, 580, 582, 584, and 586. In variations, the application resources can correspond to electronic magazines or comic books. Selection of one of the short-cuts can result in the computing device opening the particular e-book title using the e-reader application 576. The representations of each e-book can correspond to, for example, marketing imagery provided in iconic form from a publisher of the e-book.

The selection of e-books for display in the grouping 560 can be based on various criteria. For example, a prominently displayed e-book 580 can correspond to an e-book that is in progress (e.g., the user has started reading the e-book but has not completed the e-book) and/or most recently accessed. Other e-book titles can include those titles which the user has started reading (in-progress e-books), titles the user recently purchased or downloaded, titles the user recently accessed, and/or titles that are recommended to the user for reading (e.g., based on a determination of what e-books the user likes).

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for operating a computing device, the method being implemented by one or more processors and comprising:
associating each of a plurality of applications that are installed on the computing device with one of a plurality of categories;
displaying multiple groupings on an application launch interface, including at least a first grouping which includes (i) representations of one or more applications of a first category, (ii) a category identifier of the first category, and (iii) a representation of each of one or more application resources that are used by the one or more applications;
detecting a user input in connection with at least one of the multiple groupings; and
applying the user input to at least one of the multiple groupings as a single object.

2. The method of claim 1, wherein displaying multiple groupings includes displaying a second grouping which includes multiple applications of a second category.

3. The method of claim 1, wherein applying the user input includes moving the at least one of the multiple groupings relative to the other groupings.

4. The method of claim 1, wherein the plurality of categories are pre-defined categories that define a subject.

5. The method of claim 1, wherein displaying the first grouping includes displaying the representation of multiple files that are most recently or frequently accessed on the computing device.

6. The method of claim 1, wherein displaying multiple groupings of application resources includes displaying, for at least the first grouping of the multiple groupings, (i) multiple application identifiers for applications that are associated with the corresponding category of that grouping, and (ii) multiple file sets, each file set including one or more files that are available for use with an application identified by one of the multiple application identifiers.

7. The method of claim 1, wherein moving the at least one of the multiple groupings relative to the other groupings includes scrolling the multiple groupings in a vertical direction in response to user input.

8. The method of claim 1, wherein the application launch interface corresponds to a scrollable application bar, and wherein displaying multiple groupings of application resources includes displaying the multiple groupings on the application launch bar.

9. The method of claim 7, wherein moving the at least one of the multiple groupings relative to the other groupings includes moving the first grouping from a first location on the application launch screen to a second location on the application launch screen.

10. The method of claim 1, further comprising, installing a given application on the computing device, associating the given application with a first one of the plurality of categories, and including an identifier for the given application in a grouping that is associated with the first one of the plurality of categories.

11. The method of claim 1, wherein the first grouping includes representations of an e-reader application, and a representation of a portion of a user's e-book library.

12. The method of claim 11, wherein the representation of the portion of the user's e-book library includes a graphic representation of one or more e-books in the user's library.

13. The method of claim 1, wherein the first grouping includes metadata that identifies local and remote sources for e-books.

14. A computing device comprising:
one or more processors;
a memory that stores an e-book, the e-book including a plurality of pages;
a display;
wherein the one or more processors operate to:
associate each of a plurality of applications that are installed on the computing device with one of a plurality of categories;
provide, on the display, multiple groupings on an application launch interface, including at least a first grouping which includes (i) representations of one or more applications of a first category, (ii) a category identifier of the first category, and (iii) a representation of each of one or more application resources that are used by the one or more applications;
detect a user input in connection with at least one of the multiple groupings; and
applying the user input to at least one of the multiple groupings as a single object.

15. The computing device of claim 14, wherein the one or more processors provide for the first grouping to include representations of an e-reader application, and a representation of a portion of a user's e-book library.

16. The computing device of claim 15, wherein the one or more processors provide the representation of the portion of the user's e-book library to include a graphic representation of one or more e-books in the user's library.

17. The computing device of claim 15, wherein the one or more processors provide the representation of the portion of the user's e-book library to include an e-book that is in progress and most recently accessed by the user.

18. The computing device of claim 15, wherein the one or more processors provide the representation of the portion of the user's e-book library to include an e-book that is recommended to the user.

19. The computing device of claim 15, wherein the one or more processors provide the representation of the portion of the user's e-book library to include an e-book that is most recently purchased by the user.

20. A computer-readable medium that stores a set of instructions, the instructions being executable by one or more processors to cause the one or more processors to perform operations that include:
associating each of a plurality of applications that are installed on the computing device with one of a plurality of categories;
displaying multiple groupings on an application launch interface, including at least a first grouping which includes (i) representations of one or more applications of a first category, (ii) a category identifier of the first category, and (iii) a representation of each of one or more application resources that are used by the one or more applications;
detecting a user input in connection with at least one of the multiple groupings; and
applying the user input to at least one of the multiple groupings as a single object.
